(19) United States
(12) Patent Application Publication
(10) Pub. No.: US 2004/0111753 A1
(43) Pub. Date: Jun. 10, 2004

(54) Centralized nodes in a fiber optic network

(76) Inventor: Khoi Hoang, Pleasanton, CA (US)

Correspondence Address: PREDIWAVE CORPORATION, 48431 MILMONT DRIVE, FREMONT, CA, 94538, US

(21) Appl. No.: 10/314,000

(22) Filed: Dec. 5, 2002

(51) Int. Cl. H04N 7/173

(52) U.S. Cl. 725/111; 725/91

(57) ABSTRACT

The present invention contemplates centralized fiber optic nodes in a network that utilizes a fiber optic backbone for at least a portion of the downstream channel. The centralized fiber optic node is operable to process downstream data intended for customer premise equipment and provides the downstream data to a central server of the network. The central server in turn may provide the downstream data to the customer premise equipment via the network. The centralized node is further operable to receive upstream data from the customer premise equipment, the upstream data being intended for remote network servers. In an HFC system, the localized fiber optic node is replaced with a centralized node located at a central server and a simple local optical converter for interfacing to an electronic network. The centralized node enables each CPE to communicate upstream network or Internet data directly to the central server for transmission to network servers via a publicly switched telephone network (PSNT). Without sacrificing bidirectional communication, the centralized node eliminates the expense and maintenance of localized fiber optic nodes.

### CROSS-REFERENCE TO RELATED APPLICATIONS

Not applicable.

### STATEMENT REGARDING FEDERALLY SPONSORED RESEARCH

Not applicable.

### BACKGROUND OF INVENTION

1. Field of the Invention

The present invention relates to fiber optic networking, and more specifically to fiber optic networks and hybrid fiber coax networks having centralized fiber optic nodes.

2. Description of Related Art

The architects of fiber optic networks (FON) and hybrid fiber coax (HFC) networks are increasingly called upon to enable additional functionality such as Internet services at customer premise equipment (CPE) while simultaneously improving system reliability and cost effectiveness. Fundamental to meeting these demands is the use of existing infrastructure with minimal improvements, and the enablement of bi-directional communications between head-end or central servers and their clients, the CPE.

Prior Art FIG. 1 illustrates a localized node architecture for a bi-directional HFC system 10. The HFC system 10 provides the desired bi-directional communication and enables Internet services. However, as will be seen, the HFC 10 requires an expensive bi-directional fiber optic backbone. Furthermore, the HFC 10 requires an expensive and difficult to maintain localized fiber optic node at the interface between the bi-directional fiber optic backbone and a bi-directional electronic network.

Turning directly to Prior Art FIG. 1, the HFC system 10 includes a central server 12, a bidirectional fiber optic network 14, a plurality of localized fiber optic nodes 16, a plurality of bi-directional electronic networks 18, and a plurality of clients or CPE 20. The central server 12 and the fiber optic nodes 16 are interconnected by way of the fiber optic network 14. The central server 12, also referred to as a “head-end” server or service provider, provides data services such as analog television, video-on-demand (VOD), digital video broadcast (DVB), electronic program guide (EPG), and Internet services to the CPE 20.

Each localized fiber optic node 16 acts as an interface between the fiber optic network 14 and a corresponding bi-directional electronic network 18. The bi-directional electronic network provides data services to the CPE 20. A specific fiber optic node 16 and a specific bi-directional electronic network 18 are described in more detail below with reference to Prior Art FIG. 2. The clients 20 are CPE devices such as personal computers, set-top-boxes, etc.

Prior Art FIG. 2 illustrates in more detail one implementation of a fiber optic node 16 suitable for use as a localized node interfacing the fiber optic network 14 with a bi directional electronic network 18. The fiber optic node 16 includes a wave division multiplexer 30, a detector 32, a plurality of receivers 34, a code modulator 36, a combiner 38, a multiplexer 40, a microprocessor 42, a concentrator 44, and a plurality of telephone modems 46. The electronic network 18 includes a cable modem termination system 50 for downstream services and a public switched telephone network 52 for upstream services.

To accomplish the downstream interface, the fiber optic node 16 operates as follows. The wave division multiplexer 30 interfaces to optical fibers of the fiber optic network 14. Data received by the wave division multiplexer 30 transmitted over the fiber optic network 14 is processed first by the detector 32 and then the receivers 34. The receivers 34 output the data derived from the various data sources to a code modulator 36. In turn, the code modulator 36 modulates and forwards the data to a combiner 38 that outputs data to the cable modem termination system 50, which in turn broadcasts data across the network 18.

The cable modem termination system 50 is also coupled to the microprocessor 42 controlling the multiplexer 40 used to multiplex data that is transmitted back to the central server 12 from the clients 20. The clients 20 have a return path that is routed by way of the PSNT 52. To accomplish the upstream interface, the fiber optic node operates as follows. The PSNT 52 is coupled to the modems 46 each being coupled to the concentrator 44. The concentrator 44 outputs data to the multiplexer 40 that multiplexes data for input to the laser 48 that outputs data over the fiber optic network 14 by way of the wave division multiplexer 30. Thus, the telephone return path is terminated at the fiber optic node 16 using standard telephone modems 46 and the concentrator 44. This concentrated return data is multiplexed by the multiplexer 40 onto an upstream carrier using the laser 48, and is transmitted via the fiber optic network 14.

Prior Art FIG. 3 is a flow chart illustrating a method 100 showing the operation of a typical localized fiber optic node. Steps 102-106 illustrate the downstream operation of the typical fiber optic node. In a step 102, the fiber optic node receives downstream optical signals via a fiber optic network. The downstream optical signals may include video and Internet data. In a step 104, the fiber optic node converts the downstream optical signals into downstream electrical signals. In a step 106, the fiber optic node transmits the downstream electrical signals via a bi-directional network including a cable modem termination system to CPE.

With further reference to Prior Art FIG. 3, steps 108-114 illustrate the upstream operation of the typical fiber optic node. In a step 108, the fiber optic node receives upstream electrical signals from the customer premise equipment via a modem. In a step 110, the fiber optic node concentrates and multiplexes the upstream electrical signals. In a step 112, the fiber optic node converts the upstream electrical signals into upstream optical signals. Then in a final step 114, the fiber optic node transmits the upstream optical signals to a central server via the bi-directional fiber optic network.

As can be seen from the above description, prior art solutions require that a localized fiber optic node 16 be provided and maintained locally for each cable network. Failure of a localized fiber optic node requires on site repair or replacement. Prior art solutions also require bi-directional fiber optic networks, which further increase infrastructure costs.

What is needed is a mechanism for centralizing the upstream functionality of a localized network node. Such a centralizing mechanism would reduce costs of providing and maintaining a localized interface between the fiber and electronic networks. Furthermore, centralizing the upstream functions of the localized fiber optic node would eliminate the requirement of a bi-directional fiber optic backbone.

### SUMMARY OF THE INVENTION

The present invention contemplates centralized fiber optic nodes in a network that utilizes a fiber optic backbone for at least a portion of the downstream channel. In preferred embodiments, the centralized fiber optic node is operable to process downstream data intended for customer premise equipment and provide the downstream data to a central server of the network. The central server in turn may provide the downstream data to the customer premise equipment via the network. The centralized node is further operable to receive upstream data from the customer premise equipment, the upstream data being directed to the appropriate remote network server by the centralized node.

In one preferred embodiment, each centralized node includes a high speed network databus enabling communication to the remote network servers. This high speed network databus may be coupled to the Internet or other suitable wide area network. The centralized node further includes a plurality of cable modem termination systems coupled to the high speed network databus. The cable modem termination systems receive downstream Internet data via the high speed network databus and provide this data in a form suitable for generating a downstream optical signal at a later stage. To enable CPE interface with the centralized nodes, a remote access server operable to interface said customer premise equipment is coupled to the high speed network databus.

The present invention further contemplates a central server for use in a fiber optic network. The central server is capable of providing video and Internet services to customer premise equipment coupled to the fiber optic network.

In preferred embodiments, the central server includes a plurality of centralized fiber optic nodes coupled to a high speed Internet connection. These centralized fiber optic nodes can provide downstream Internet services intended for customer premise equipment. The centralized fiber optic nodes can also process upstream Internet data received from the customer premise equipment and forward the upstream Internet data to Internet servers via the high speed Internet connection.

According to related embodiments, the central server further comprises digital service and analog services. The digital services may include digital video-on-demand, digital video broadcast, and EPG data. The analog service may include analog video. The central server may further include an optical transmission system for generating, from the variety of services, a downstream optical signal for transmission to the customer premise equipment via the fiber optic network.

The present invention further contemplates a bi-directional hybrid fiber coax data communications system having centralized fiber optic nodes. The data communications system includes a fiber optic network for transmission of downstream optical signals such as video and Internet services, an optical converter for converting the downstream optical signals into downstream electrical signals, and a cable network for distributing the downstream electrical signals to customer premise equipment. The data communications system further includes a telephone line for transmitting upstream electrical signals from the customer premise equipment, and a central server for generating said downstream optical signals, and processing said upstream electrical signals.

### BRIEF DESCRIPTION OF DRAWINGS

These and other objects, features and characteristics of the present invention will become more apparent to those skilled in the art from a study of the following detailed description in conjunction with the appended claims and drawings, all of which form a part of this specification. In the drawings:

PRIOR ART FIG. 1 illustrates a localized node architecture for a bi-directional HFC system;

PRIOR ART FIG. 2 is a block diagram of a fiber optic node interfacing a bi directional fiber optic network with a bi-directional electronic network;

PRIOR ART FIG. 3 is a flow chart illustrating the operation of a localized fiber optic node;

FIG. 4 is a block diagram of a bi-directional HFC system in accordance with one embodiment of the present invention;

FIG. 5 is a block diagram of a centralized node in accordance with yet another embodiment of the present invention;

FIG. 6 is a block diagram of an optical converter in accordance with still another embodiment of the present invention;

FIG. 7 is a flow chart illustrating a method for transmitting downstream data services including Internet services from a central server to a plurality of CPE; and

FIG. 8 is a flow chart illustrating a method for transmitting upstream Internet data from a plurality of CPE to a central server without the use of a localized fiber optic node.

### DETAILED DESCRIPTION OF THE INVENTION

The present invention teaches a variety of methods and systems for centralizing certain operations of a fiber optic node into a head-end or central server. For example, in one preferred HFC system of the present invention, the localized fiber-optic node is replaced with a centralized node located at a central server and a local optical converter interfacing the fiber optic backbone to an electronic network. The centralized node enables each CPE to communicate upstream network or Internet data to the central server via a publicly switched telephone network (PSNT) for subsequent transmission to network servers. Without sacrificing bidirectional communication, the centralized node eliminates the expense and maintenance of localized fiber optic nodes.

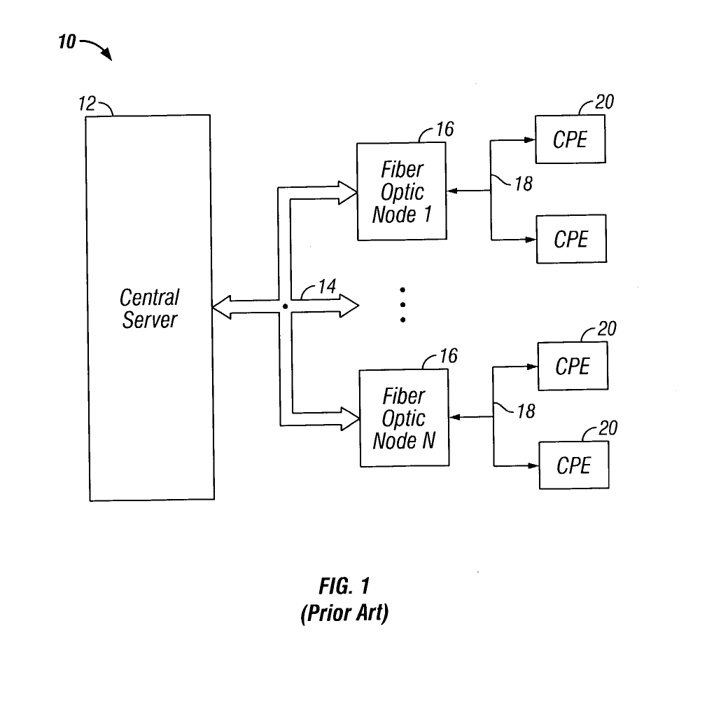

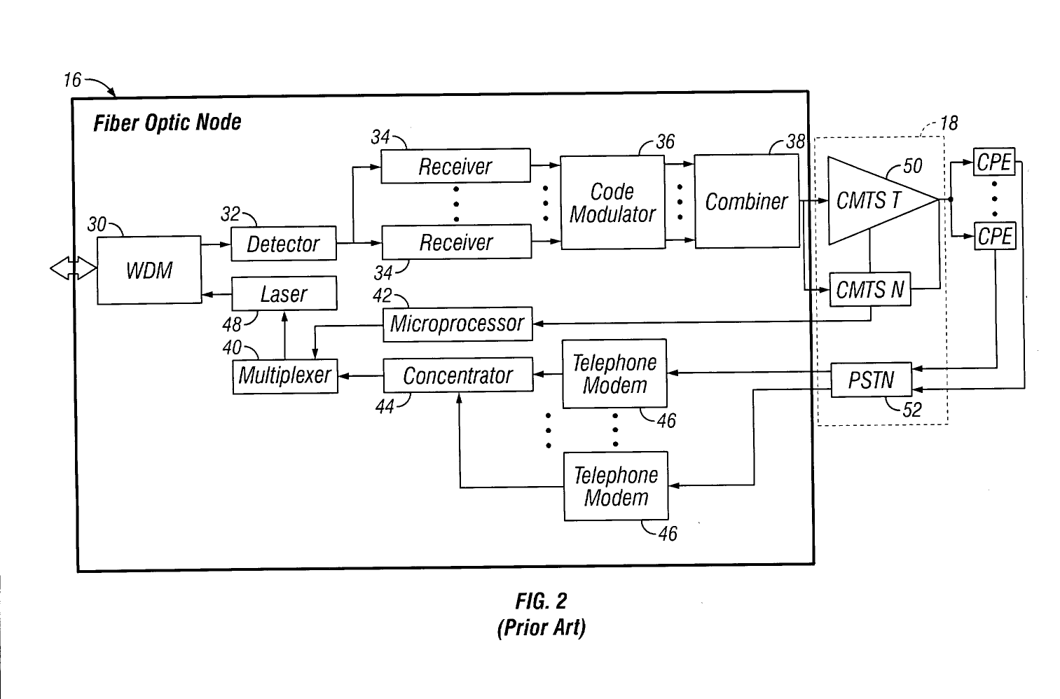

FIG. 4 is a block diagram of a bi-directional HFC data communications system 200 in accordance with one embodiment of the present invention. The data communications system 200 may be used for a variety of applications such as a television network, and it is contemplated that the system 200 would be capable of providing Internet services, video-on-demand services, digital and analog video services, etc. The HFC system 200 includes a central server 202, an analog fiber optic network 204, a plurality of optical converters 206, a plurality of cable modem termination systems (CMTS) 208, a plurality of customer premise equipment (CPE) 210, and a public switched telephone network (PSNT) 212.

The central server 202 includes digital services 220, analog services 222, network services 224, a digital services modulator 226, a combiner 228, a network service modulator 230, a microwave multiplexer 232, a laser 234, and a wave division multiplexer (WDM) 236. The digital services 220 include services such as digital data on-demand (video and other), digital video broadcast, and EPG data. The analog services 222 include analog video services. Data from the digital services 220 and the network services 224 is modulated at modulators 226 and 230 respectively, and then combined with the analog services 222 at combiner 228 to generate a downstream electrical signal. This downstream electrical signal is then converted into a downstream analog optical signal via processing by the microwave multiplexer 232, the laser 234 and the WDM 236 in a manner that will be appreciated by those skilled in the art.

The network services 224 of the central server 202 include a plurality of centralized fiber optic nodes 240 and a remote access server 242. The remote access server 242 is coupled to the CPE 210 via PSTN 212. The remote access server 242 receives upstream Internet signals from the plurality of CPE 210, and provides these upstream Internet signals in a suitable form to the appropriate centralized node 240. The centralized nodes 240 act as a bi-directional interface with the Internet, receiving downstream Internet signals from Internet servers and transmitting upstream Internet signals to those same Internet servers.

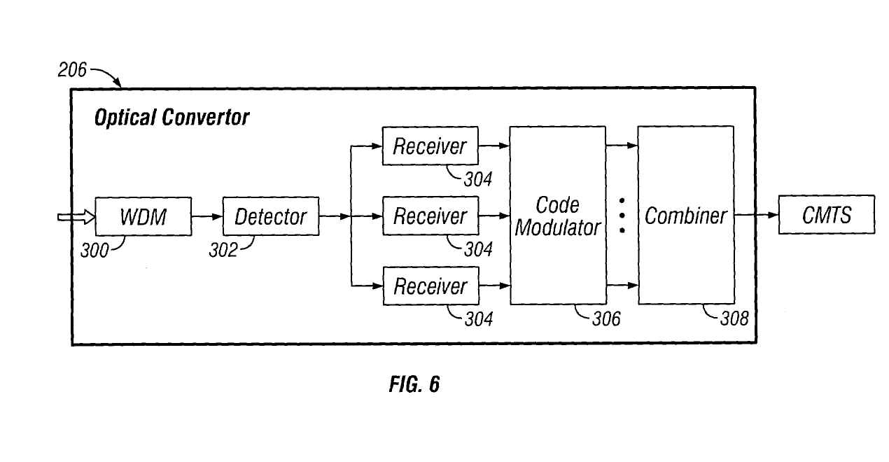

The optical converters 206 are each located at a corresponding cable network and provide an interface between the analog fiber optic network 204 and the corresponding cable modem termination system 208. One suitable embodiment for an optical converter 206 is described below in more detail with reference to FIG. 6. The cable modem termination systems 208 make up a cable network used for providing downstream digital, analog and Internet services to the CPE 210.

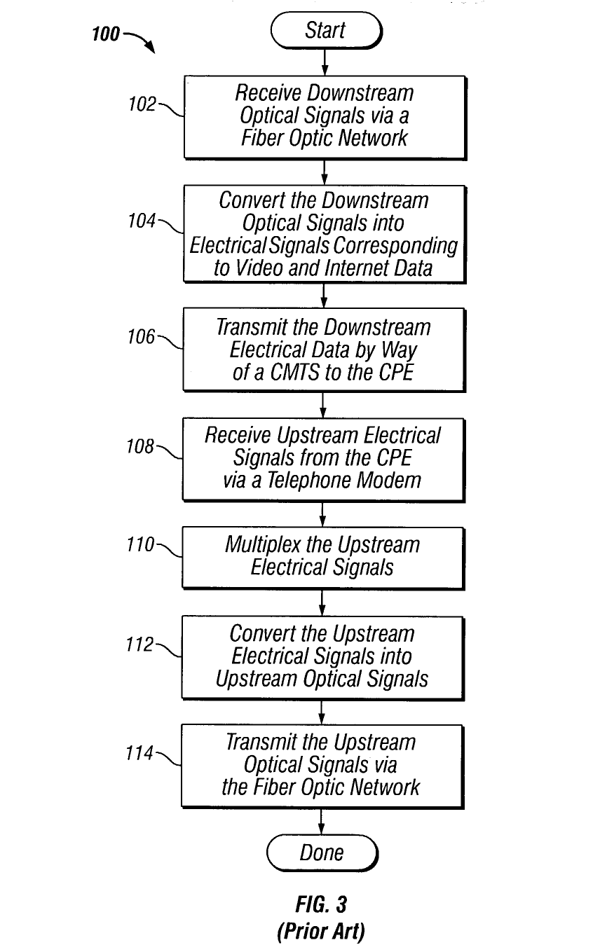

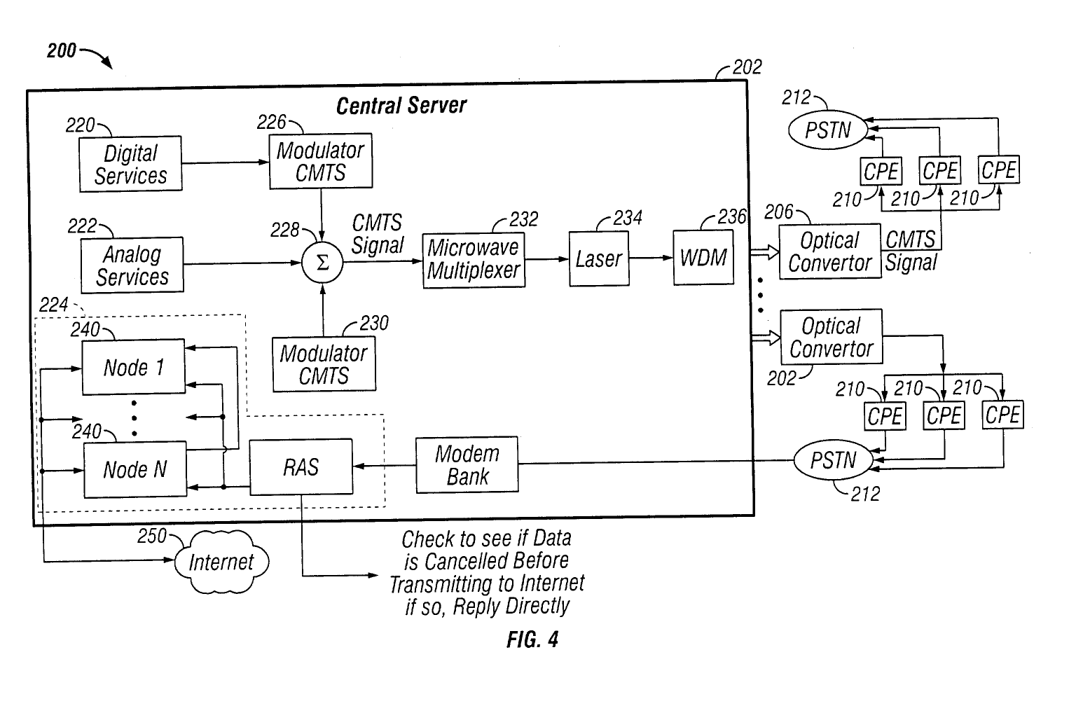

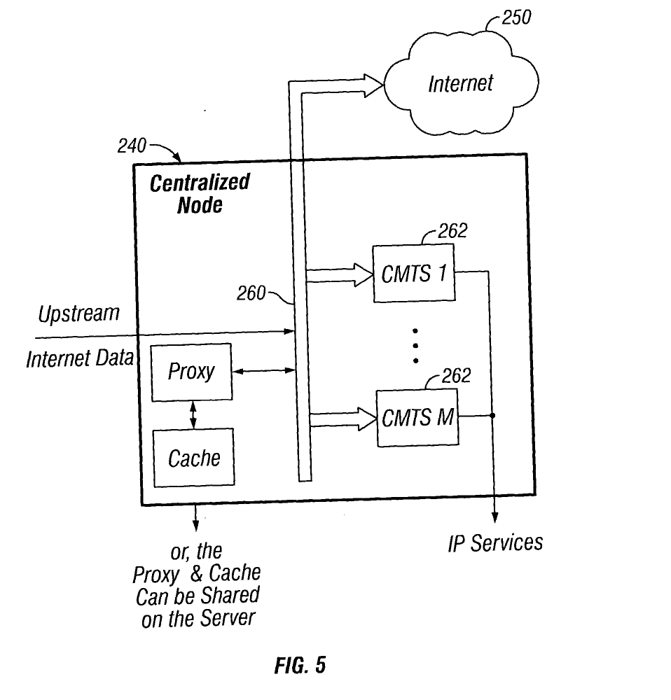

With reference to FIG. 5, a centralized fiber optic node 240 in accordance with one embodiment of the present invention will now be described. Each centralized fiber optic node 240 corresponds to a particular cable network and includes a high speed network databus 260 and a plurality of CMTS 262. The plurality of CMTS 262 receive downstream Internet data via the high speed network databus 260 and provide a downstream electrical signal Internet services intended for the CPE of the corresponding cable network output. The central server outputs this downstream electrical signal for conversion to an optical signal.

With reference to FIG. 6, an optical converter 206 in accordance with one embodiment of the present invention will now be described. The optical converter 206 includes a WDM 300, a detector 302, a plurality of receivers 304, a code modulator 306, and a combiner 308. The WDM 300 interfaces to optical fibers of the fiber optic network 204. Downstream data received by the wave division multiplexer 300 transmitted over the fiber optic network 204 is processed first by the detector 302 and then the receivers 304. The receivers 304 output the data derived from the various data sources to a code modulator 306. In turn, the code modulator 306 modulates and forwards the data to a combiner 308 that outputs data to the cable modem termination system 208, which in turn broadcasts data to the variety of CPE 210.

The data communication systems of the present invention require only the optical converter 206 is localized rather than the expensive and complicated fiber optic nodes 16 of the prior art data communications systems. This is because the complicated structure of the upstream interface has been centralized at the central server 202 via the centralized nodes 240. As a result, the providing and maintaining of localized fiber optic nodes has been eliminated by the present invention.

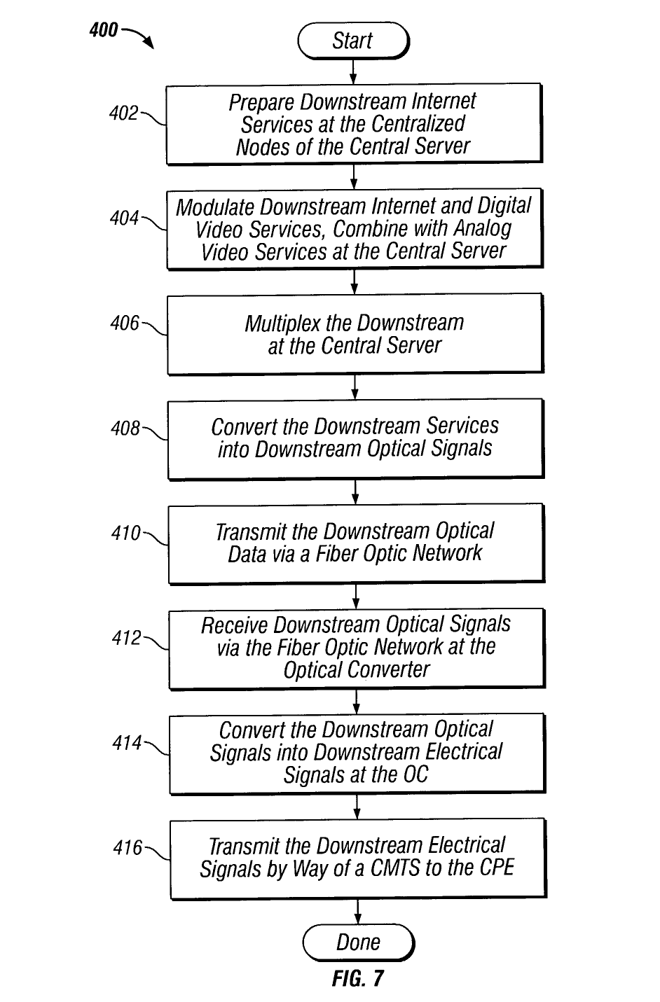

FIG. 7 is a flow chart illustrating a computer implemented method 400 for providing downstream services from a central server to a plurality of CPE in accordance with one aspect of the present invention. In a first step 402, centralized nodes of a central server prepare downstream network services. Step 402 may include receiving data intended for specific CPE from a variety of Internet servers or other devices coupled to the computer server via a computer network. In step 402 the network services are combined and provided as output for combination with other services. In a step 404, the network services and digital services are modulated and combined with analog services. In a step 406, the combined downstream services are multiplexed. Then in a step 408 the multiplexed downstream services are converted into a downstream optical signals and in a next step 410 the downstream optical signals are transmitted via a fiber optic network.

At an optical converter terminating the fiber optic network, a step 412 receives the optical downstream signals. A step 414 converts the downstream optical signals into downstream electrical signals that in a step 416 are transmitted via a cable network to the CPE.

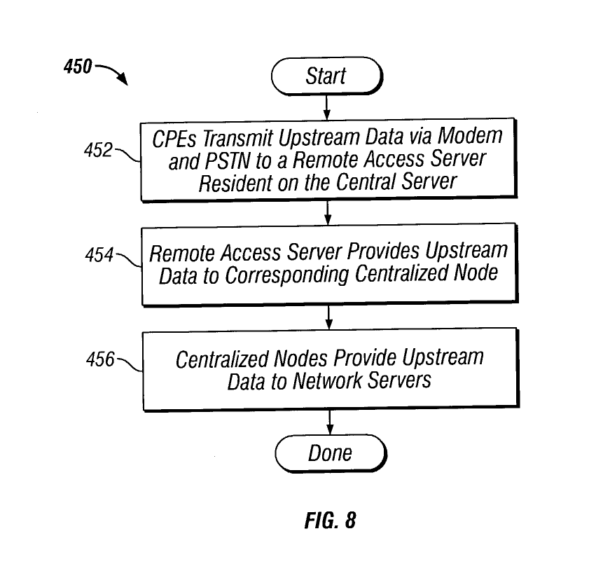

FIG. 8 is a flow chart illustrating a computer implemented method for providing upstream services in accordance with yet another aspect of the present invention. In a step 452, a CPE transmits upstream data via a telephone modem and a PSTN to a remote access server (RAS) resident on the central server. Note that each particular CPE will correspond to a particular centralized node on the central server. Accordingly, in a step 454 the RAS will process and route the upstream data to the corresponding centralized node. The centralized node will then transmit the upstream data across the network to the appropriate network server.

In addition to the above mentioned examples, various other modifications and alterations of the invention may be made without departing from the invention.

The centralized node concept of the present invention may be readily applied to many network architectures differing from the HFC system 200 described above with reference to FIG. 4. The downstream channel may utilize a variety of different network infrastructures. For example, a portion of the downstream channel may take the form of a satellite link, or perhaps the fiber network extends to each CPE, or the network may include a variety of different infrastructures. Likewise, the upstream channel may take a variety of different forms as long as the goal of simplifying the local interface is accomplished. This may be done by using existing infrastructure such as Digital Subscriber Line (DSL) technology rather than PSTN.

The present invention also contemplates that centralized nodes and localized nodes may both be used within a data communications system. That is, centralized nodes may be used for certain CPE networks, while localized fiber optic nodes may be used for other CPE networks.

The central server 200 shown above in FIG. 4 included a variety of functionality which may be provided physically in one computer system or may be separated into a variety of components. For example, the centralized nodes and the optical network interface equipment may well be housed in separate devices.

Accordingly, the above disclosure is not to be considered as limiting and the appended claims are to be interpreted as encompassing the true spirit and the entire scope of the invention.

We claim:

1. A data communications interface node for use as a centralized fiber optic node in a fiber optic network, said node operable to process downstream data intended for customer premise equipment, said node further operable to provide said downstream data to a central server of said fiber optic network such that said central server may provide said downstream data to said customer premise equipment via said fiber optic network, said node further operable to receive upstream data from said customer premise equipment, said upstream data intended for remote network servers.

2. A node as recited in claim 1, said node comprising:
a high speed network databus for coupling said node to said remote network servers;
a plurality of cable modem termination systems coupled to said high speed network databus; and
a remote access server coupled to said high speed network databus, said remote access server operable to interface said customer premise equipment to said high speed network databus.

3. A central server for use in a fiber optic network, said central server capable of providing video and Internet services to customer premise equipment coupled to said fiber optic network, said central server comprising:
a plurality of centralized fiber optic nodes coupled to a high speed Internet connection, said plurality of centralized fiber optic nodes operable to provide downstream Internet services intended for said customer premise equipment, said plurality of centralized fiber optic nodes further operable to process received upstream Internet data from said customer premise equipment and forward said upstream Internet data to Internet servers via said high speed Internet connection

4. A central server as recited in claim 3, wherein each of said plurality of centralized fiber optic nodes comprises:
a high speed network databus for coupling said node to said high speed Internet connection;
a plurality of cable modem termination systems coupled to said high speed network databus; and
a remote access server coupled to said high speed network databus, said remote access server operable to interface said customer premise equipment to said high speed network databus.

5. A central server as recited in claim 3 further comprising:
digital services;
analog services; and
an optical transmission system capable of generating, from said Internet services, said digital services, and said analog services, a downstream optical signal for transmission to said customer premise equipment via said fiber optic network.

6. A central server as recited in claim 5, wherein said digital services include digital data-on-demand.

7. A central server as recited in claim 6, wherein said digital digital data-on-demand include digital video-on-demand.

8. A central server as recited in claim 5, wherein said digital services include digital video broadcast data.

9. A central server as recited in claim 5, wherein said analog services include analog video data.

10. A central server for use in a fiber optic network, said central server capable of providing video and Internet services to customer premise equipment coupled to said fiber optic network, said central server comprising:
a plurality of centralized fiber optic nodes coupled to a high speed Internet connection, said plurality of centralized fiber optic nodes operable to provide downstream Internet services intended for said customer premise equipment, said plurality of centralized fiber optic nodes further operable to process received upstream Internet data from said customer premise equipment and forward said upstream Internet data to Internet servers via said high speed Internet connection, each of said plurality of centralized fiber optic nodes including a high speed network databus for coupling said node to said high speed Internet connection, a plurality of cable modem termination systems coupled to said high speed network databus and a remote access server coupled to said high speed network databus, said remote access server operable to interface said customer premise equipment to said high speed network databus;
digital services;
analog services; and
an optical transmission system capable of generating, from said Internet services, said digital services, and said analog services, a downstream optical signal for transmission to said customer premise equipment via said fiber optic network.

11. A central server as recited in claim 10, wherein said digital video services include digital data-on-demand.

12. A central server as recited in claim 11, wherein said digital data-on-demand includes digital video-on-demand.

13. A central server as recited in claim 11, wherein said digital services include digital video broadcast data.

14. A central server as recited in claim 11, wherein said analog services include analog video data.

15. A bidirectional hybrid fiber coax data communications system having centralized fiber optic nodes, said data communications system comprising:
a fiber optic network for transmission of downstream optical signals such as video and Internet services;
an optical converter for converting said downstream optical signals into downstream electrical signals;
a cable network for distributing said downstream electrical signals to customer premise equipment;
a telephone line for transmitting upstream electrical signals from said customer premise equipment; and
a central server for generating said downstream optical signals, and processing said upstream electrical signals, said central server including:
a plurality of centralized fiber optic nodes coupled to a high speed Internet connection, said plurality of centralized fiber optic nodes operable to provide downstream Internet services intended for said customer premise equipment, said plurality of centralized fiber optic nodes further operable to process received upstream Internet data from said customer premise equipment and forward said upstream Internet data to Internet servers via said high speed Internet connection, each of said plurality of centralized fiber optic nodes including a high speed network databus for coupling said node to said high speed Internet connection, a plurality of cable modem termination systems coupled to said high speed network databus and a remote access server coupled to said high speed network databus, said remote access server operable to interface said customer premise equipment to said high speed network databus;
digital services;
analog services; and
an optical transmission system capable of generating, from said Internet services, said digital services, and said analog services, said downstream optical signal for transmission to said customer premise equipment via said fiber optic network.

16. A computer implemented method for controlling a central server used within a hybrid fiber coax network system, said method comprising the acts of:
receiving from remote servers downstream Internet signals intended for customer premise equipment;
preparing a downstream optical signal for transmission to customer premise equipment, said downstream optical signal including said downstream Internet signals intended for said customer premise equipment;
transmitting said downstream optical signal via a fiber optic network;
receiving from said customer premise equipment upstream Internet signals intended for remote servers via a telephone line;
preparing said upstream Internet signals intended for remote servers for transmission to said remote servers; and
transmitting said upstream Internet signals to said remote servers.

17. A computer implemented method as recited in claim 16, wherein the act of preparing a downstream optical signal for transmission includes the sub-acts of:
providing said downstream Internet signals to a plurality of cable modem termination systems; and
combining the output of said plurality of cable modem termination systems to generate an electrical signal from which the Internet portion of said downstream optical signal can be generated.
